(19) United States
(12) Patent Application Publication
(10) Pub. No.: US 2002/0186140 A1
(43) Pub. Date: Dec. 12, 2002

(54) Apparatus and method for detecting a change in fluid flow

(76) Inventor: Alan Anderson, Portsmouth (GB)

Correspondence Address: NOTARO & MICHALOS P.C., EMPIRE STATE BUILDING, SUITE 6902, 350 FIFTH AVENUE, NEW YORK, NY, 10118-6985, US

(21) Appl. No.: 10/116,215

(22) Filed: Apr. 4, 2002

(30) Foreign Application Priority Data
Apr. 7, 2001 (GB) 0108786.5

(51) Int. Cl. G08B 21/00

(52) U.S. Cl. 340/606; 340/610; 340/612; 340/618; 340/619; 340/620; 340/621

(57) ABSTRACT

Apparatus 1 for detecting a change of flow rate of a fluid being pumped through a pipe 2, the apparatus 1 comprises a cylindrical chamber 4, a fluid sensor 6 disposed on the side of the chamber 4, alarm means 8 and a vent valve 10 located at a distal enclosed end of the chamber 4. The chamber 4 extends upwardly from the pipe 2 and is formed with a port 4 at the lowermost end of the chamber 4. The lower end of the chamber 4 is formed with a port 7 that extends through the wall of the pipe 2 such that the inner region of the chamber 4 is in fluid communication with the pipe 2 via the port 7. The fluid sensor 6 may be a solid state liquid level switch such as an optical liquid level switch. It will be appreciated that other types of fluid level sensors may be used. The fluid sensor 6 is in communication with the alarm means.

The present invention relates to apparatus and a method for detecting a change in a flow rate of a fluid and is concerned particularly, although not exclusively, with alarm apparatus and a method for detecting a flow rate of a fluid below a predetermined level.

In many different situations it is desirable to monitor the flow rate of a fluid through a pipe. For many processes or devices the flow rate can be critical to the working of the process or the device. One such situation is an engine cooling system of a waterborne vessel. The engine cooling fluid for a vessel is normally taken from the water in which the vessel floats. This cooling fluid is also used as lubrication for the impeller of the pump. The cooling system is prone to blockage from flotsam and jetsam in the water. If there is a reduction in the cooling fluid flow the engine may over heat and the pump impeller may be damaged. It is important, therefore, to have some means for detecting a blockage and providing an indication of the blockage in the cooling system. Existing fluid flow meters comprise a physical element, such as a turbine, that is placed in the flow stream. These types of flow meters have been found to be unreliable and may disrupt or restrict the flow of the fluid. Such flow meters are particularly unsuitable for fluids that contain particles or debris.

According to a first aspect of the present invention there is provided alarm apparatus for detecting a change of flow rate of a fluid being pumped through a pipe, the alarm apparatus comprising a chamber, fluid sensor means disposed at a point along the chamber and alarm means, the arrangement being such that an internal portion of the chamber is in fluid communication with the pipe and in use fluid from the pipe extends along a portion of the chamber, the alarm means being activated when the fluid sensor means detects the level of fluid within the chamber does not extend as far as the fluid sensor.

The chamber is preferably disposed upstream of fluid pumping means for the pipe.

The alarm means is preferably activated when the fluid sensor means detects a change in the level of fluid within the chamber.

Preferably the arrangement is such that in use, in a first condition the fluid within the chamber extends beyond the fluid sensor such that the fluid sensor detects the presence of fluid and in a second condition the fluid within the chamber has receded along the chamber in a direction towards the pipe such that the fluid sensor does not detect the presence of the fluid and the alarm means is activated.

The chamber is preferably a tubular form comprising a closed distal end.

The chamber preferably comprises venting means.

The venting means is preferably disposed at the point distant from the closed distal end of the chamber.

The venting means is preferably a valve.

In an alternative embodiment of the present invention the venting means is disposed at the closed distal end of the chamber.

Preferably the chamber extends upwardly in a direction away from the pipe.

The chamber is preferably substantially vertical.

The apparatus preferably comprises means for damping the fluid within the chamber.

The fluid damping means is preferably disposed between the fluid sensor means and the pipe.

The fluid damping means preferably restricts the flow of fluid between the chamber and the pipe.

Preferably the fluid damping means is formed by a reduced cross-sectional diameter of the chamber.

According to a second aspect of the present invention there is provided apparatus for detecting a change of a fluid flow in a pipe, the apparatus comprising a chamber in fluid communication with an inner portion of the pipe and sensor means disposed along the chamber, the arrangement being such that, in use, some of the fluid being transported through the pipe extends along a portion of the chamber, the amount that the fluid extends through the chamber being proportional to the pressure of the fluid in the pipe and the sensor means detects whether the fluid within the chamber has reached a predetermined point.

The chamber is preferably of tubular form comprising a closed distal end.

The chamber preferably comprises venting means.

The venting means is preferably a valve.

The venting means is preferably disposed distant from the closed distal end.

Preferably the chamber extends upwardly in a direction away from the pipe.

The chamber is preferably substantially vertical.

The chamber is preferably disposed upstream of fluid pump means for the pipe.

The apparatus preferably comprises means for damping the fluid within the chamber.

The fluid damping means is preferably disposed between the fluid sensor means and the pipe.

The fluid damping means preferably restricts the flow of fluid between the chamber and the pipe.

Preferably the fluid damping means is formed by a reduced cross-sectional diameter of the chamber.

According to a third aspect of the present invention there is provided alarm apparatus for detecting a change of cooling fluid flow rate through an engine cooling system of a waterborne vessel, the alarm apparatus comprising a chamber a portion of which extends through the wall of a pipe of the engine cooling system and is in fluid communication therewith; fluid sensor means disposed at a point along the chamber and alarm means, the arrangement being such that, in use, in a first condition the fluid within the chamber extends beyond the fluid sensor and is distant from the distal end of the chamber such that the fluid sensor detects the presence of fluid and in a second restricted flow condition in the pipe the fluid within the chamber recedes along the chamber in a direction towards the pipe such that the fluid sensor does not detect the presence of the fluid and the alarm means is activated.

The chamber is preferably partially filled with fluid and partially filled with an expandable medium disposed at the distal end of the chamber.

The alarm means is preferably activated when the fluid sensor means detects the level of fluid within the chamber does not extend to the fluid sensor.

The chamber is preferably of tubular form comprising a closed distal end. Preferably the chamber extends upwardly in a direction away from the pipe.

The chamber is preferably disposed upstream of fluid pump means for the pipe.

The alarm apparatus preferably comprises means for damping the fluid within the chamber.

The fluid damping means is preferably disposed between the fluid sensor means and the pipe.

The fluid damping means preferably restricts the flow of fluid between the chamber and the pipe.

Preferably the fluid damping means is formed by a reduced cross-sectional diameter of the chamber.

According to a fourth aspect of the present invention there is provided a method for detecting a change of a fluid flow in a pipe, the method comprising a first step of detecting whether a fluid within a chamber in fluid communication with the pipe extends beyond a fluid sensor such that the fluid sensor detects the presence of the fluid and a second step of detecting whether the fluid within the chamber has receded along the chamber in a direction towards the pipe such that the fluid sensor does not detect the presence of the fluid.

Preferably the method comprises a third step of activating an alarm means if the fluid sensor does not detect the presence of the fluid.

There are particular advantages to combining the features of the various aspects of the present invention and the invention may include any combination of the features or limitations referred to herein.

The present invention may be carried into practice in various ways and an embodiment will now be described, by way of example only, with reference to the accompanying drawings in which:

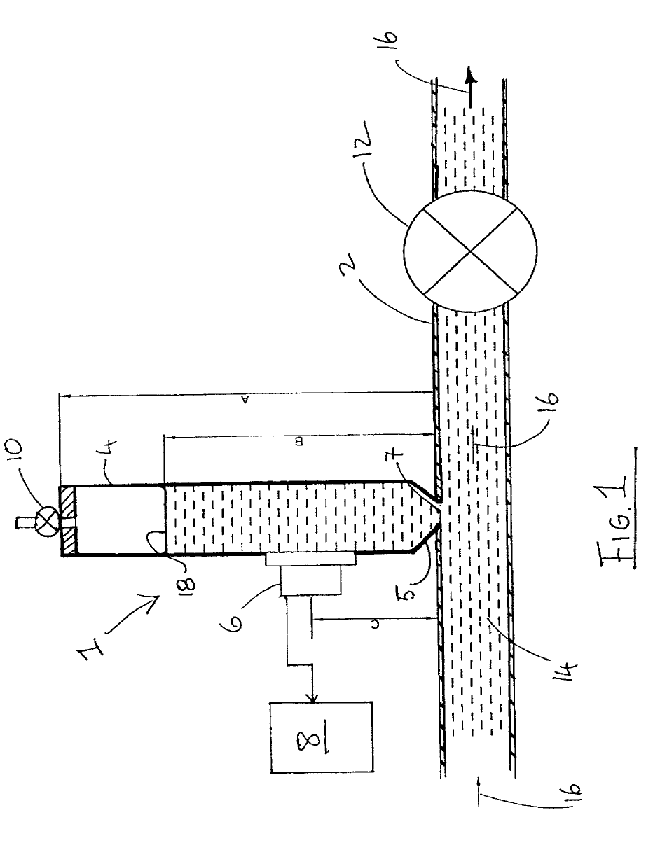

FIG. 1 is a partial cross-section view of apparatus and for detecting a change in a flow rate of a fluid within a pipe; and

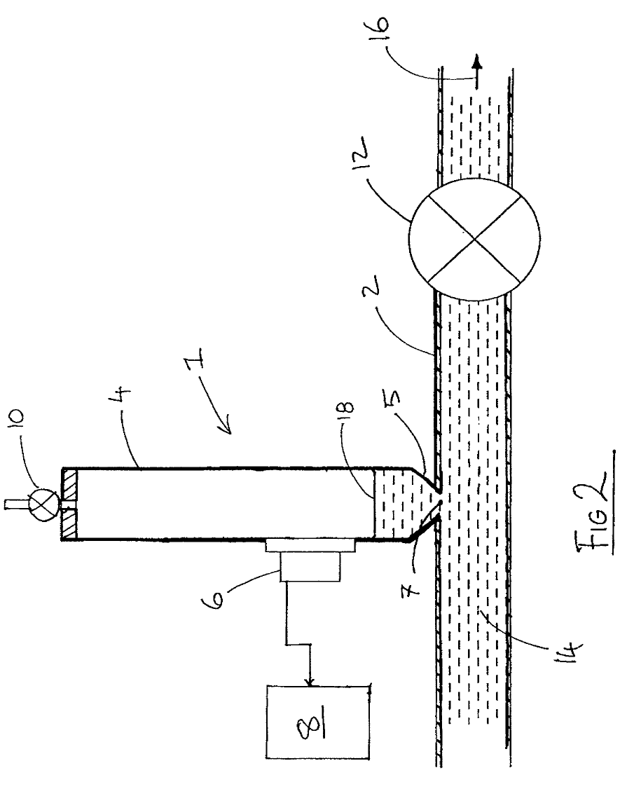

FIG. 2 is a partial cross-section view of the apparatus shown in FIG. 1 and shows the pipe with a restricted flow.

With reference to FIG. 1, apparatus 1 for detecting a change of flow rate of a fluid being pumped through a pipe 2, the apparatus 1 comprises a cylindrical chamber 4, a fluid sensor 6 disposed on the side of the chamber 4, alarm means 8 and a vent valve 10 located at a distal enclosed end of the chamber 4. The chamber 4 extends upwardly from the pipe 2 and is formed with a port 4 at the lowermost end of the chamber 4. The lower end of the chamber 4 is formed with a port 7 that extends through the wall of the pipe 2 such that the inner region of the chamber 4 is in fluid communication with the pipe 2 via the port 7. The fluid sensor 6 may be a solid state liquid level switch such as an optical liquid level switch. It will be appreciated that other types of fluid level sensors may be used. The fluid sensor 6 is in communication with the alarm means.

The chamber 4 comprises fluid damping means in the form of a reducing portion 5 of the chamber wall. The portion 5 is a frusto-conical shape having a reduced cross-sectional area. The reduced cross-sectional area of the port 7 limits the flow of fluid between the chamber 4 and the pipe 2. It will be appreciated that other suitable fluid damping means may be used. The fluid damping means provides damping of the level 18, distance ‘B’, in response to varying pressure fluctuations of the fluid in the pipe 2.

Downstream of the chamber 4 is a fluid pump 12. In use the pump 12 transfers the fluid 14 in direction 16 through the pipe 2.

FIG. 1 shows a normal running condition. The fluid level 18 within the chamber 4 is above the fluid sensor 6. In the running condition the vent valve 10 is closed. The vent valve 10 may be used to correctly calibrate the chamber 4 for a normal running conditions. When the pipe is first filled with fluid there will be air trapped in the chamber 4. The vent valve 10 is opened to allow some of the air to escape thus allowing the fluid from the pipe to enter the chamber 4 and fill the chamber 4 to a desired level. The vent valve 10 is closed once the desired level has been reached. Some air remains within the distal region of the chamber 4 to help prevent a vacuum forming within the chamber 4 and allowing the level of the fluid in the chamber to vary in response to changing fluid pressure in the pipe 2. The air acts as an expandable medium. If the chamber 2 does become completely filled with fluid then air or other gas may be forced into the upper part of the chamber through the vent valve 10. For example, a gas pump or a compressor may be connected to the vent valve 10 and used to force a gas into the upper part of the chamber 4.

In a preferred alternative embodiment of the present invention the vent valve 10 is disposed on the side of the chamber 4. In this embodiment the vent valve 10 on the side of the chamber 4 is opened allowing air within the chamber 10 to escape from the chamber 4. The release of the air from the chamber 4 allows the level of fluid within the chamber 4 to extend further along the chamber 4. The valve 10 is kept open until the fluid within the chamber 4 has reached the valve 10 and starts to pass through the valve 10. The vent valve 10 is closed once the fluid starts to escape. Ideally, the valve 10 is disposed at a distance ‘B’ from the pipe 2.

If there is a blockage or a restriction of the supply of fluid 14 to the pipe 2 the level 18 within the chamber 4 will be drawn in a direction towards the pipe by the action of the pump 12. The pressure of the air in the chamber 4 above the level 18 decreases as the level 18 is drawn towards the pipe 2. When the level 18 passes beyond the sensor 6, as shown in FIG. 2, the sensor 6 communicates this condition to the alarm means 8 and the alarm means 8 is activated to warn an operator of the problem. The alarm means 8 may be an audible alarm and a visual alarm. One particularly useful application of the apparatus 1 is for detecting a blockage of an engine cooling system of a water vessel. The engine cooling fluid for a water vessel is normally taken from the water in which the vessel floats. This cooling fluid is also used as lubrication for the impeller of the pump. The cooling system is prone to blockage from flotsam and jetsam in the water. If there is a reduction in the cooling fluid flow the engine may over heat and the pump impeller may be damaged. A cooling system fitted with apparatus 1 would provide an alarm for such a situation. The apparatus 1 may be disposed between a fluid inlet port and a fluid pump of the system. If the inlet port of a cooling system did become restricted then the level in the chamber 4 would be drawn below the sensor 6 by the pump and the alarm would be triggered. The cooling system of a water vessel is normally located below the water line of the vessel such that even in a non operative state there is a fluid pressure within the system.

There is shown below a table of some typical technical data of two test apparatus according to the present invention and with reference to the lengths A, B and C shown in FIG. 1.

| | Chamber 4 Diameter 10 mm | Chamber 4 Diameter 50 mm |
|---|---|---|
| Length A | 460 mm | 570 mm |
| Length B | 330 mm | 260 mm |
| Length C | 150 mm | 150 mm |

Flow rate for a small pump/tube=17 liters per minute.

Flow rate for a large pump/tube=480 liters per minute.

The apparatus 1 of present invention may also be used for detecting a change of a fluid flow in the pipe 2. In use, the amount that the fluid 14 extends through the chamber 4 is proportional to the pressure of the fluid 14 through the pipe 2. When the pressure of the fluid 14 changes the level 18 will also change and the fluid sensor 6 can be used to detect whether the fluid within the chamber 4 has reached a predetermined point and therefore whether the pressure of the fluid in the pipe 2 is at a certain rate.

1. Alarm apparatus for detecting a change of flow rate of a fluid being pumped through a pipe, the alarm apparatus comprising a chamber comprising an enclosed distal end and a proximal end formed with a port connectable to said pipe, fluid sensor means disposed at a point along the chamber between the enclosed end and the proximal end and alarm means, the arrangement being such that an internal portion of the chamber is in fluid communication with the pipe via the port and in use the chamber is partially filled with fluid from the pipe, the alarm means being activated when the fluid sensor means detects the level of fluid within the chamber does not extend as far as the fluid sensor.

2. Alarm apparatus according to claim 1, wherein the chamber is disposed upstream of fluid pumping means for the pipe.

3. Alarm apparatus according to claim 2, wherein the chamber is a tubular form comprising the enclosed distal end and the proximal end formed with the port.

4. Alarm apparatus according to claim 3, wherein the chamber extends upwardly in a direction away from the pipe.

5. Alarm apparatus according to claim 4, wherein the chamber is substantially vertical.

6. Alarm apparatus according to claim 1, wherein the chamber comprises venting means.

7. Alarm apparatus according to claim 6, wherein the venting means is disposed at the point distant from the enclosed distal end of the chamber.

8. Alarm apparatus according to claim 7, wherein the venting means is a valve.

9. Alarm apparatus according to claim 6, wherein the venting means is disposed at the enclosed distal end of the chamber.

10. Alarm apparatus according to claim 1, wherein the apparatus comprises means for damping the fluid within the chamber.

11. Alarm apparatus according to claim 10, wherein the fluid damping means is disposed between the fluid sensor means and the pipe.

12. Alarm apparatus according to claim 11, wherein the fluid damping means restricts the flow of fluid between the chamber and the pipe.

13. Alarm apparatus according to claim 12, wherein the fluid damping means is formed by a reduced cross-sectional diameter of the chamber.

14. Apparatus for detecting a change of a fluid flow in a pipe, the apparatus comprising a chamber comprising an enclosed distal end and a proximal end formed with a port connectable to said pipe and being in fluid communication with an inner portion of the pipe and sensor means disposed along the chamber, the arrangement being such that, in use, some of the fluid being transported through the pipe extends along a portion of the chamber, the amount that the fluid extends through the chamber being proportional to the pressure of the fluid in the pipe and the sensor means detects whether the fluid within the chamber has reached a predetermined point.

15. Apparatus for detecting a change of a fluid flow in a pipe according to claim 14, wherein the chamber extends upwardly in a direction away from the pipe.

16. Apparatus for detecting a change of a fluid flow in a pipe according to claim 15, wherein the chamber is substantially vertical.

17. Apparatus for detecting a change of a fluid flow in a pipe according to claim 14, wherein the chamber is a tubular form comprising the enclosed distal end and the proximal end formed with the port.

18. Apparatus for detecting a change of a fluid flow in a pipe according to claim 14, wherein the chamber comprises venting means.

19. Apparatus for detecting a change of a fluid flow in a pipe according to claim 18, wherein the venting means is a valve.

20. Apparatus for detecting a change of a fluid flow in a pipe according to claim 18, wherein the venting means is disposed distant from the closed distal end.

21. Apparatus for detecting a change of a fluid flow in a pipe according to claim 14, wherein the chamber is disposed upstream of fluid pump means for the pipe.

22. Apparatus for detecting a change of a fluid flow in a pipe according to claim 14, wherein the apparatus comprises means for damping the fluid within the chamber.

23. Apparatus for detecting a change of a fluid flow in a pipe according to claim 22, wherein the fluid damping means is disposed between the fluid sensor means and the pipe.

24. Apparatus for detecting a change of a fluid flow in a pipe according to claim 23, wherein the fluid damping means restricts the flow of fluid between the chamber and the pipe.

25. Apparatus for detecting a change of a fluid flow in a pipe according to claim 24, wherein the fluid damping means is formed by a reduced cross-sectional diameter of the chamber.

26. Alarm apparatus for detecting a change of cooling fluid flow rate through an engine cooling system of a vessel, the alarm apparatus comprising a chamber comprising an enclosed distal end and a proximal end formed with a port which extends through the wall of a pipe of the engine cooling system and is in fluid communication therewith; fluid sensor means disposed at a point along the chamber and alarm means, the arrangement being such that, in use, in a first condition the fluid within the chamber extends beyond the fluid sensor and is distant from the enclosed distal end of the chamber such that the fluid sensor detects the presence of fluid and in a second restricted flow condition in the pipe the fluid within the chamber recedes along the chamber in a direction towards the pipe such that the fluid sensor does not detect the presence of the fluid and the alarm means is activated.

27. Alarm apparatus according to claim 26, wherein the alarm means is activated when the fluid sensor means detects the level of fluid within the chamber does not extend to the fluid sensor.

28. Alarm apparatus according to claim 26, wherein the chamber is a tubular form comprising a closed distal end.

29. Alarm apparatus according to claim 28, wherein the chamber extends upwardly in a direction away from the pipe.

30. Alarm apparatus according to claim 26, wherein the chamber is disposed upstream of fluid pump means for the pipe.

31. Alarm apparatus according to claim 26, wherein the alarm apparatus comprises means for damping the fluid within the chamber.

32. Alarm apparatus according to claim 31, wherein the fluid damping means is disposed between the fluid sensor means and the pipe.

33. Alarm apparatus according to claim 32, wherein the fluid damping means restricts the flow of fluid between the chamber and the pipe.

34. Alarm apparatus according to claim 33, wherein the fluid damping means is formed by a reduced cross-sectional diameter of the chamber.

35. A method for detecting a change of a fluid flow in a pipe, the method comprising a first step of detecting whether a fluid, within a chamber comprising an enclosed distal end and a proximal end formed with a port in fluid communication with the pipe, extends beyond a fluid sensor such that the fluid sensor detects the presence of the fluid and a second step of detecting whether the fluid within the chamber has receded away from the enclosed distal along the chamber in a direction towards the pipe such that the fluid sensor does not detect the presence of the fluid.

36. A method according to claim 35, wherein the method comprises a third step of activating an alarm means if the fluid sensor does not detect the presence of the fluid.
